(19) United States
(12) Patent Application Publication
(10) Pub. No.: US 2004/0154525 A1
(43) Pub. Date: Aug. 12, 2004

(54) GUIDANCE WAND

(76) Inventors: Steven E. Wirth, Bloomington, MN (US); Todd J. Olson, New Ulm, MN (US)

Correspondence Address: Roger W. Jensen, Roger W. Jensen & Associates, Ltd., 8127 Pennsylvania Circle, Minneapolis, MN, 55438, US

(21) Appl. No.: 10/361,545

(22) Filed: Feb. 10, 2003

(51) Int. Cl. G01D 11/00

(52) U.S. Cl. 116/1

(57) ABSTRACT

A hand-held guidance wand for use by a grounded human to guide a moveable dirigible craft. The wand comprises a straight, longitudinally elongated, polygonal-cross-sectioned member. The wand is preferably hollow and has either a triangular or a square cross-section.

### BACKGROUND OF THE INVENTION

This invention relates to a guidance wand for use by a grounded human to guide a moveable, dirigible craft so that the craft may be safely and properly moved to an intended resting point. The expression “grounded human” is intended to mean a human positioned on the ground such as an airport worker on an airport runway apron or “tarmac”, or the marine equivalent, e.g., positioned in a watercraft or on the flight deck of an aircraft carrier. The expression “dirigible craft” is intended to mean any and all moveable vehicles such as aircraft, cars, trucks, and boats.

A well known prior art use of a guidance wand is the guidance provided to aircraft by humans holding wands to aid the positioning of the aircraft, before the engines are stopped, properly with respect to the airport arrival gates. The said prior art guidance wands are generally described by having a round cross section, usually are colored red or blaze orange, and usually have an associated battery-powered flash light means to illuminate the wand (this being important to permit the pilot (of the aircraft being guided)) to see the wand for all conditions of low visibility such as at night and during periods of fog, rain, or snow.

The prior art wands have two major shortcomings. The first is that because of the round cross section the wands, if on the ground and left unattended by the human, are prone to roll along the ground, i.e., flat surface, by the force of the wind. The second is that the wands require frequent changes of batteries; this is a negative, regard being given to the factors of increased weight, labor cost, material cost, and having convenient locations of spare batteries. The present invention provides a guidance wand that is not subject to the above noted shortcomings of the prior art devices.

### SUMMARY OF THE INVENTION

The present invention comprises a substantially straight, elongated, polygonal-cross-sectioned member having a longitudinal axis, a preselected length, and a preselected number of substantially flat longitudinally extending sides.

The preferred embodiment of the invention comprises a lightweight, hand-held guidance wand for use by a human to guide a moveable dirigible craft, e.g., an aircraft taxiing on the tarmac of an airport; the wand being hollow and longitudinally elongated, having a triangular cross section, and being made, at least in part, of luminescent material. This embodiment may also include reflective means on at least one of the three sides.

The wand may also include, on at least one of the sides, longitudinally extending and spaced apart ridges defining therebetween flat surfaces for positioning of reflective means. The ridges also provide protection to the reflective means.

Thus the invention provides a guidance wand with a polygonal cross section, e.g., three sided which, if left unattended on the tarmac or a flight deck, is not prone to be moved by the wind as is the case with the prior art wands. Further, our wand, being of luminescent material, does not require in integral battery-operated light means. The aforementioned ridges have, as mentioned, the function of defining a flat, longitudinally extending surface for positioning or fastening of light reflective means and have a further utility in that they make the wand easier to pick up.

At nighttime, a pilot being guided by a wand utilizing our invention will, with relative ease, see the wand first because of its inherent luminescence and second because the aircraft ground lights will be reflected back to the aircraft from the reflective means on the wand.

### DESCRIPTION OF THE DRAWING

FIG. 1 is an isometric view of a first embodiment of our invention showing an elongated, hollow guidance wand AA having an equilateral triangular cross section;

FIG. 2 is a cross-sectional view of the wand, as viewed along section lines 2-2 of FIG. 3;

FIG. 3 is an elevational view of the wand depicted in FIG. 1;

FIG. 4 is an isometric view of a second embodiment BB of our invention;

FIGS. 5 and 5A are cross-sectional views of wand BB, as viewed along section lines 5-5 and 5A-5A of FIG. 6;

FIG. 5B is a cross-sectional view of a portion of a modification of the wand shown in FIG. 4;

FIG. 6 is an elevational view of the wand depicted in FIG. 4;

FIG. 7 is an isometric view of a third embodiment CC of our invention;

FIGS. 8 and 8A are cross-sectional views of wand CC, as viewed along sections lines 8-8 and 8A-8A of FIG. 9; and

FIG. 9 is an elevational view of the wand depicted in FIG. 7.

### DETAILED DESCRIPTION OF THE INVENTION

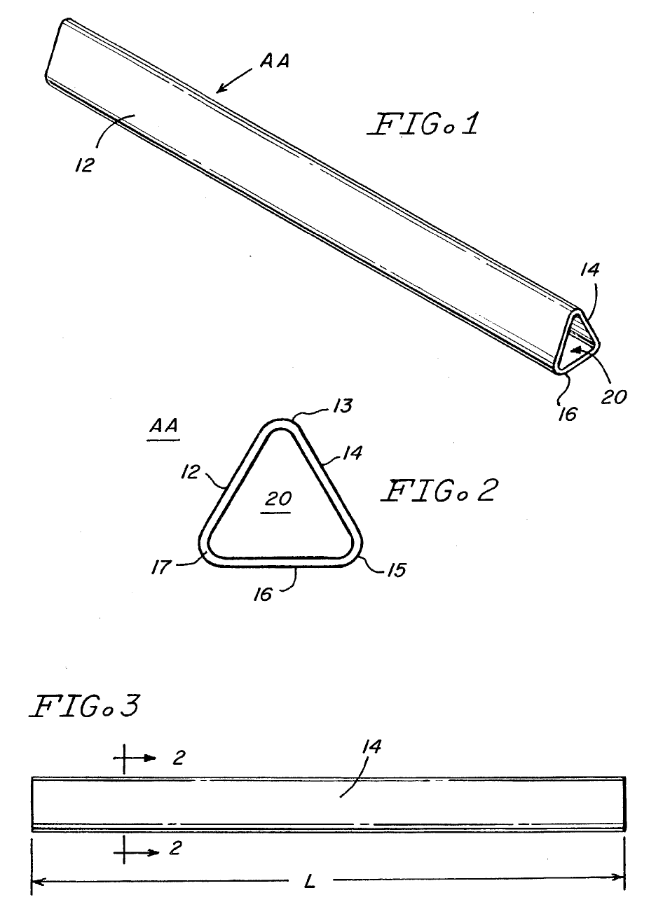

Referring to FIG. 1, the reference symbol AA designates a first embodiment of our invention, i.e., a guidance wand having a substantially straight, elongated, polygonal-cross-sectioned member having a preselected longitudinal length L (shown in FIG. 3), a longitudinal axis LA, and a preselected number of substantially flat longitudinally extending sides, i.e., three sides 12, 14, and 16 (see FIGS. 1 & 2).

The polygonal-cross-sectioned member, as indicated for this embodiment, has three sides which is very advantageous as compared to a prior art guidance wand having a round cross section. A three-sided wand is per se very stable against lateral (perpendicular to the longitudinal axis) movement under strong wind forces, i.e., is not prone to roll about its longitudinal axis when unattended on a flat surface.

The guidance wand AA not only has three sides which define a triangular cross section, but the three sides 12-16 are of equal width, giving the cross section an equilateral triangle shape as is clearly shown in FIG. 2, the three corners of the triangle being designated 13, 15, and 17.

The guidance wand AA may be of solid construction or, as shown in FIGS. 1 and 2, the wand is hollow as designated by reference numeral 20. The thickness of the sides 12, 14, and 16 is selected to provide desired strength and weight as is well understood by those skilled in the art.

A preferred version of the wand shown in FIGS. 1-3 is made from a colored luminescent material such as a specialized polyethylene (provided in bulk pellet form) sold by companies such as Breen Color Concentrates, Inc. of Lambertville, N.J., under catalog designators Yellow BX 761 B or C LDPE. The aforesaid luminescent material is of the phosphorescent type, i.e., glow in the dark. The color orange is a preferred color for the wand but other colors may be selected. The wands are manufactured from the bulk material using a suitable plastic molding process, e.g., extrusion as are well known by those skilled in the art. If an extrusion process is selected, the extruded product can, as it emerges from the extrusion machine, be cut to the preselected longitudinal length L.

In actual use, to activate or energize the guidance wands having the phosphorescent property, the wands would be placed in a high light intensity zone or environment for a sufficient time to produce the desired amount of energization.

An alternate type of luminescent material is fluorescent, which gives off light but only when illuminated by black light. It should be understood that the scope of this invention is intended to cover guidance wands made in whole or in part of fluorescent, luminescent material.

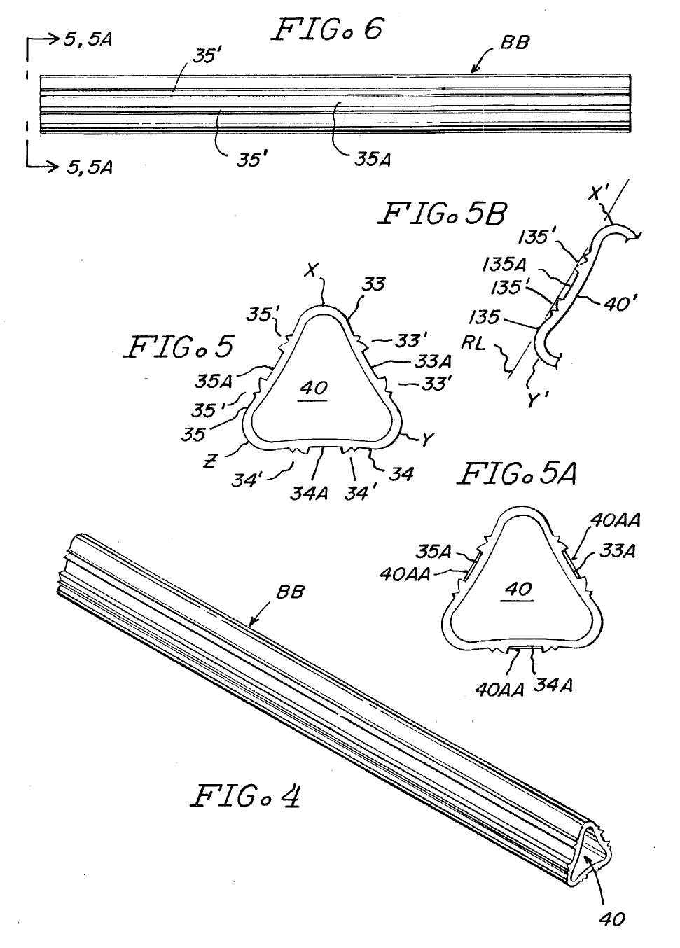

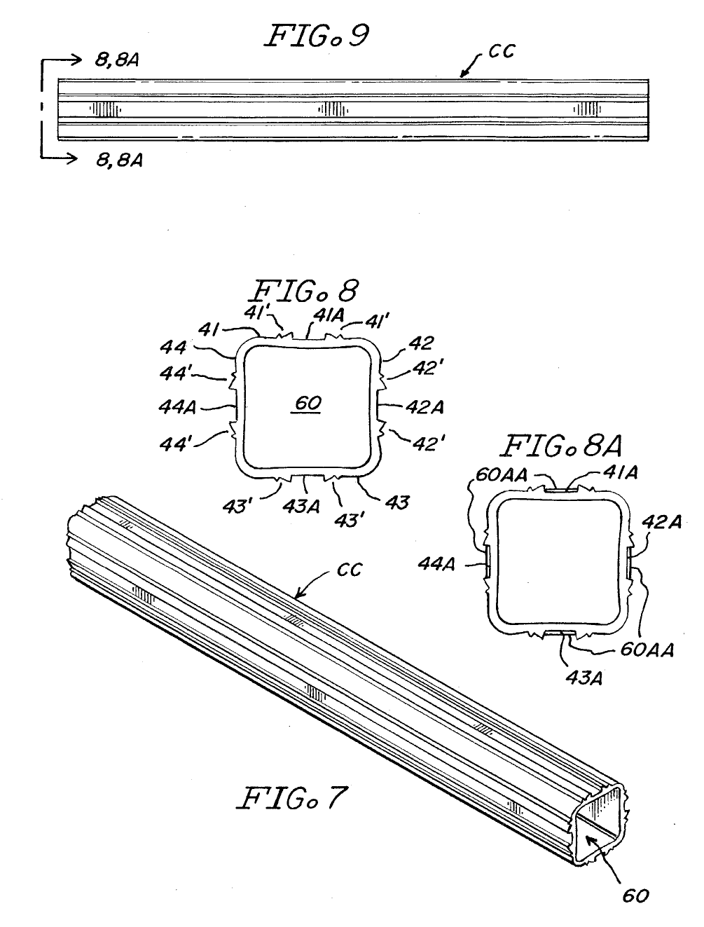

The preferred embodiment of our invention is the guidance wand BB depicted in FIGS. 4-6. Wand BB also is straight, longitudinally elongated, with a three-sided equilateral triangular cross section. The three sides are designated 33, 34, and 35. The three corners are designated X, Y and Z. The wand BB is preferably hollow as designated by the reference numeral 40.

Wand BB is further characterized by having a plurality of longitudinally extending sets of ridges 33′, 34′, and 35′ extending outwardly from sides 33, 34 and 35 respectively. The sets of ridges are each spaced laterally apart to define a substantially flat longitudinally extending surface, i.e., sets of ridges 33′, 34′, and 35′ define flat surfaces 33A, 34A, and 35A, respectively.

Again, as for the first embodiment, it is preferred to have the guidance wand made of luminescent material of the phosphorescent type so the wand will glow in the dark.

Additionally, our invention contemplates, for some applications, a reflective means on the wands for all of the embodiments shown. In the case of the embodiment of FIGS. 4-6, a reflective means in the form of light reflective strips 40AA are attached or bonded to the flat surfaces 33A, 34A, and 35A of the wand as is shown in FIG. 5A. The ridges 33A-35A provide an important function of protecting the reflective strips 40AA against being unintentionally removed during use by abrasion against the ground or the like.

The longitudinally extending ridges 33′, 34′, and 35′ have an additional function of providing gripping surfaces to ease the gripping and picking up of the guidance wand by the hands of the human guiders.

The ridges 33′, 34′, and 35′ are shown in FIG. 5 to extend outwardly slightly past the tangent lines for the three corners X, Y, and Z. An alternate arrangement is shown in FIG. 5B where a set of ridges 135′ (spaced apart to define a flat surface 135A on side 135) extend only to a tangent or reference line RL which abuts the two depicted wand corners X′ and Y′. It will be noted from FIG. 5B, that the side 135 is slightly bowed inwardly as at 40′ to facilitate the above noted relationship of the ridges and the reference line RL.

A four sided or square cross-sectioned guidance wand embodiment CC shown in FIGS. 7-9 also is straight and longitudinally elongated to a preselected length. Wand CC is shown in the preferred hollow configuration (reference 60) but could be solid if desired.

The four sides 41, 42, 43 and 44 each respectively have a set of longitudinally extending ridges 41′, 42′, 43′ and 44′ which in turn respectively define longitudinally extending flat surfaces 41A, 42A, 43A and 44A (see FIG. 8) to which may be bonded or otherwise attached reflective means 60AA (see FIG. 8A).

The ridges 41′-44′ protect the reflective means 60AA as explained above. In addition, the square cross section guidance wand CC may be easier for the human guider to grasp or pick up. Again, the wand preferably is made of luminescent material of the phosphorescent type and, optionally, may include the reflective means 60AA.

Thus, we have shown several embodiments of polygonal-cross-sectioned and elongated guidance wands, i.e., having triangular and square cross-sections. The scope of the invention is intended to cover other polygons. The wands are exceedingly light, durable, and long lasting. They do not require the heavy and expensive batteries of the prior art wands.

While the preferred embodiment of the invention has been illustrated, it will be understood that variations may be made by those skilled in the art without departing from the inventive concept. Accordingly, the invention is to be limited only by the scope of the following claims.

1. A hand-held guidance wand for use by a grounded human to guide a moveable, dirigible craft, said wand comprising a substantially straight, elongated, polygonal-cross-sectioned member having a longitudinal axis and with both a preselected longitudinal length and a preselected number of substantially flat longitudinally extending sides.

2. The wand of claim 1 further characterized by said member being hollow.

3. The wand of claim 1 further characterized by at least one of said sides having a plurality of longitudinally extending ridges.

4. The wand of claim 3 further characterized by said plurality of longitudinally extending ridges being spaced laterally apart to define a substantially flat longitudinally extending surface.

5. The wand of claim 4 further characterized by including light reflecting means integral with said substantially flat longitudinally extending surface.

6. The wand of claim 2 further characterized by including light reflecting means on at least one of said sides.

7. The wand of claim 1 wherein said wand has a substantially triangular cross-section.

8. The wand of claim 1 wherein said wand has a substantially square cross-section.

9. The wand of claim 7 wherein said wand is hollow, at least one of said sides has a plurality of longitudinally extending ridges laterally spaced apart to define a substantially flat longitudinally extending surface, and light reflective means on said surface.

10. The wand of claim 8 wherein said wand is hollow, at least one of said sides has a plurality of longitudinally extending ridges laterally spaced apart to define a substantially flat longitudinally extending surface, and light reflective means on said surface.

11. A hand-held guidance wand for use by a human to guide a moveable dirigible craft, said wand, at least in part, being manufactured from luminescent material and further comprising a substantially straight, elongated, polygonal-cross-sectioned member having a longitudinal axis, a preselected longitudinal length, and a preselected number of substantially flat longitudinally extending sides.

12. The wand of claim 11 further including light reflective means on at least one of said sides.

13. The wand of claim 11 wherein said preselected number of sides is three to define an equilateral triangle-shaped cross-section with three corners.

14. The wand of claim 11 wherein said preselected number of sides is four.

15. The wand of claim 13 further characterized by (a) at least one of said sides having a plurality of longitudinally extending and spaced apart ridges to thus define a flat surface, and (b) light reflective means on said flat surface.

16. The wand of claim 15 further characterized by (a) said wand being hollow, (b) said preselected sides being curved inwardly between said corners, and (c) said ridges extending outwardly a preselected distance.

17. The wand of claim 14 further characterized by (a) at least one of said sides having a plurality of longitudinally extending and spaced apart ridges to thus define a flat surface, and (b) light reflective means on said flat surface.

18. The wand of claim 17 further characterized by (a) said wand being hollow, (b) said preselected sides being curved inwardly between adjacent corners, and (c) said ridges extending a preselected distance outwardly from said sides.
